(19) United States
(12) Patent Application Publication
(10) Pub. No.: US 2014/0088885 A1
(43) Pub. Date: Mar. 27, 2014

(54) METHOD, AN APPARATUS, AND A COMPUTER PROGRAM PRODUCT FOR IDENTIFYING METABOLITES FROM LIQUID CHROMATOGRAPHY-MASS SPECTROMETRY MEASUREMENTS

(71) Applicant: Dong-Yup Lee, Singapore (SG)

(72) Inventor: Dong-Yup Lee, Singapore (SG)

(21) Appl. No.: 14/004,674

(22) PCT Filed: Mar. 9, 2012
(86) PCT No.: PCT/SG2012/000079

§ 371 Date: Nov. 25, 2013

(30) Foreign Application Priority Data
Mar. 11, 2011 (SG) 201101774-6

(51) Int. Cl. G01N 30/90; G01N 30/96

(52) U.S. Cl. CPC G01N 30/90; G01N 30/96
USPC 702/25

(57) ABSTRACT

The present invention relates to a method for identifying metabolites present in a set of samples. The method may include: (a) forming a plurality of peak-groups, wherein each peak-group comprises mass peaks representative of a specific ion in each chromatographic run; (b) forming a plurality of clusters, wherein each cluster comprises at least one peak-group of (a) each having similar chromatographic profiles; and (c) generating a list of metabolite predictions, wherein each metabolite prediction is selected from the plurality of clusters of (b).

### CROSS-REFERENCE TO RELATED APPLICATION

This application claims the benefit of priority of Singapore Patent Application No. 201101774-6, filed 11 Mar. 2011, the contents of which being hereby incorporated by reference in its entirety for all purposes.

### TECHNICAL FIELD

The invention relates to methods of identifying metabolites in a set of samples, and in particular, to methods of identifying metabolites in a set of samples measured using liquid chromatography-mass spectrometry. An apparatus and a computer program product for identifying metabolites in a set of samples are also provided.

### BACKGROUND

Metabolomics is a rapidly emerging field involving the measurement and study of small molecules in biological systems. These small molecules, known as metabolites, are the end products of cellular processes, and thus their levels most directly reflect the phenotypic state of a biological system. This makes metabolomics a valuable tool within the systems biology framework for investigating cellular responses to perturbations, with the aim of developing better understanding of complex biological systems.

Metabolomics has been applied to study various systems including microbial, plant, animal, and human. Metabolomic approaches can either be targeted or untargeted. The former focuses on quantifying and evaluating a selected group of metabolites from a certain metabolic pathway or class of compounds. On the other hand, untargeted metabolic profiling involves the global analysis of metabolite signals measured by one or more analytical platforms. Such platforms are high-throughput, generating huge amounts of data which will require statistical and computational tools to identify and characterize metabolites pertinent to the study. This approach is designed for hypothesis generation, and thus there is generally limited biological knowledge of the entity under investigation. This, coupled with the complexity of data, poses a major challenge to metabolomics investigators.

Liquid chromatography-mass spectrometry (LC-MS) is one of the most commonly used analytical platforms for untargeted metabolomics studies. Metabolites in a complex sample are first separated via chromatographic-based methods, most often as a function of their polarities. This results in their elution at different retention times (RT). The eluting analytes are ionized, typically by electrospray ionization (ESI), and further separated in the mass spectrometer according to their mass-to-charge ratio (m/z). At each time point, a mass spectrum, which depicts the m/z of each eluting compound and its corresponding intensity, is generated. The resulting data for the entire chromatographic run can be visualized as a three-dimensional plot, where each peak represents a detected ion and is characterized by its m/z, RT and intensity (FIG. 7).

Advances in technology, such as ultra-performance liquid chromatography (UPLC), the Orbitrap mass analyzer, and the Fourier Transform Ion Cyclotron Resonance (FT-ICR) mass analyzer, have allowed increases in throughput, sensitivity and mass resolution, thus making LC-MS a powerful tool for metabolic profiling.

Meaningful biological insights can only be gained when identities of the metabolites producing interesting features are correctly determined. Despite the rich information provided by the analytical instruments, there is limited ability to identify metabolites, making this a major bottleneck in data interpretation. Current LC-MS technologies are capable of generating large and complex datasets. A typical LC-MS run on a biological sample often consists of thousands of peaks after initial filtering and detection. This complexity is further compounded when multiple runs from a number of samples are analyzed together. Additionally, there is limited knowledge of the natural metabolites occurring in various organisms. Even the human metabolome has not yet been fully characterized. Information being accumulated in metabolite databases is insufficient at the moment and it is difficult to standardize experimental data for sharing because of dependency on analytical conditions. Therefore, metabolite identification remains a challenge and there are currently relatively few systematic and automated methods available to resolve this. Accordingly, manual inspection and annotation are often required for reliable identification. There is thus an urgent need for more sophisticated computational tools to aid this time-consuming task.

Metabolite identification broadly falls under two categories: definitive and putative. Definitive identification, being at a higher level of confidence, requires at least two orthogonal properties to be matched to those of an authentic standard. These are typically m/z coupled with either RT or tandem mass spectrometry (MS/MS) fragmentation pattern. A number of tools and databases are available to aid definitive identification. However, this approach requires availability of the standards as well as measurement of their properties under the same experimental conditions. For these reasons, definitive identification may not always be achievable and will require additional laborious experiments.

In view of the above, putative metabolite identification is often used, especially in the early stages of analysis. Such putative identification method employs one or more properties to determine metabolite identity, but does not require comparison to authentic standards. Typically, m/z is the main property used, but orthogonal information such as RT can also be employed, especially to differentiate isomers. Candidate molecular formulae (elemental compositions) are first assigned to each peak based on m/z, followed by matching of these formulae to chemical and metabolite databases to determine putative identity. Freely available databases include the Human Metabolome Database (HMDB), the Mouse Multiple Tissue Metabolome Database (MMMDB), the Madison Metabolomics Consortium Database (MMCD), the Kyoto Encyclopedia of Genes and Genomes (KEGG), the Manchester Metabolomics Database (MMD), the Aberystwyth University High Resolution Mass Spectrometry Laboratory database (MZedDB), and PubChem. Putative identification can also be obtained by directly matching m/z to records in these resources without generating molecular formulae.

However, current established putative metabolite identification methods do not address a key issue commonly encountered in LC-MS data analysis, which is, while the number of detected features in a LC-MS run typically ranges in the thousands, they actually correspond to a much smaller set of metabolites. This is because during ionization, each metabolite can form several adduct and fragment ions which are detected as different features. Isotopic peaks of these ions would also register as separate features. The types of ions being formed depend on sample composition and analytical setup, making it difficult to predict which ions a metabolite will form. Additionally, some features may also be the result of noise and instrument artifacts. If not accounted for appropriately, all these features will dramatically increase the likelihood of false identifications, generating numerous candidates that need to be manually examined and verified. They also add to the dimensionality of data, thereby complicating the analysis work.

Therefore, there remains a need to provide for a method to fully exploit the rich LC-MS data in order to generate better metabolite identity candidates.

### Summary

The present invention relates to a method that is specifically designed to generate accurate metabolite identity predictions based on comprehensive interrogation of liquid chromatography-mass spectrometry (LC-MS) data. The method may be implemented by a fully automated computer program.

According to a first aspect of the invention, there is provided a method for identifying metabolites present in a set of samples. The method may include:

(a) forming a plurality of peak-groups, wherein each peak-group comprises mass peaks representative of a specific ion in each chromatographic run;

(b) forming a plurality of clusters, wherein each cluster comprises at least one peak-group of (a) each having similar chromatographic profiles; and

(c) generating a list of metabolite predictions, wherein each metabolite prediction is selected from the plurality of clusters of (b).

According to a second aspect of the invention, there is provided an apparatus for identifying metabolites present in a set of samples, the apparatus comprising:

(i) at least one processor; and

(ii) at least one memory including computer program code; wherein the at least one memory and the computer program code are being configured with the at least one processor to cause the apparatus to perform at least the following:

(a) forming a plurality of peak-groups, wherein each peak-group comprises mass peaks representative of a specific ion in each chromatographic run;

(b) forming a plurality of clusters, wherein each cluster comprises at least one peak-group of (a) each having similar chromatographic profiles; and

(c) generating a list of metabolite predictions, wherein each metabolite prediction is selected from the plurality of clusters of (b).

According to a third aspect of the invention, there is provided a computer program product for identifying metabolites present in a set of samples, the computer program product comprising at least one computer-readable storage medium having computer-executable program code instructions stored therein, the computer-executable program code instructions comprising:

(a) program code for forming a plurality of peak-groups, wherein each peak-group comprises mass peaks representative of a specific ion in each chromatographic run;

(b) program code for forming a plurality of clusters, wherein each cluster comprises at least one peak-group of (a) each having similar chromatographic profiles; and

(c) program code for generating a list of metabolite predictions, wherein each metabolite prediction is selected from the plurality of clusters of (b).

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 shows an overall workflow of the present method.

FIG. 2 shows an example of peak matching for three hypothetical features with very similar m/z and RT. (a) Graph (m/z vs RT) showing the locations of neighboring peaks from four runs. Ungrouped peaks are partitioned according to a fixed slice width in the RT dimension. Moving across the RT axis, each slice starts from the first peak that is not yet in a peak-group (the target peak). In the first iteration, starting from p1, eight peaks are incorporated into slice1 (including p2, p3 and p4). (b) Graph showing the peaks of slice1 along the m/z axis. The algorithm detects a large enough m/z jump (˜0.4) as it scans down the m/z axis, thus it ignores those peaks beyond the jump and groups the target peak (p1), along with three others, into peak-group1. (c) Graph showing the peaks of slice2 along the m/z axis. The target peak is p3, the next ungrouped peak with the smallest RT. Along the m/z axis, the peaks are not separated by an m/z jump, thus they are initially grouped together. However, because there are extra peaks from the same sample (e.g. p3 and p5 both from Run1), the algorithm proceeds to separate them by k-means clustering in two dimensions (m/z and RT), shown in (d). The value of k is two since there are up to two peaks of the same run. After clustering, the one containing the target peak (p3) forms peak-group2, while the other cluster is ignored. Returning back to the full dataset, the process is repeated again, this time with slice3 starting from p5.

FIG. 3 shows an example of IP clustering. The figure shows the density maps for four different runs, along with 3D plots of the regions marked by the dotted boxes. Three peak-groups are being considered for this example (PG1-PG3). The step first clusters peak-groups in the RT domain by comparing the chromatographic peak profiles within individual runs. From the 3D plots, it appears that the peak shapes are similar in all four runs and are located at similar RT. The step then examines the intensity ratios between pairs of peaks. The intensity ratio between peaks of PG1 and PG3 in run 4 appears to be very different from the rest of the runs, thus PG3 is separated from the cluster of PG1 and PG2.

FIG. 4 shows an example of predicting metabolite mass from the m/z list of an ionization product cluster. Isotopic peak-groups are first linked to their corresponding monoisotopic peak-groups and removed. The remaining m/z are used to generate metabolite mass candidates based on a list of ionization product types known to form (not all shown in figure). Finally, the candidates are searched for matching masses within an error tolerance. In this case, 3 candidates match, resulting in a prediction with mass ˜181.07 (grey boxes). The prediction score is calculated by summing the scores associated with the IP types of matching candidates.

FIG. 5 shows the distributions of the sizes of IP-clusters ((a) columns) and metabolite mass predictions, in both the positive (a) and negative (b) ion modes. Predictions are further broken into: all predictions ((b) columns), those that have a database match ((c) columns), and those that correctly match to media metabolites ((d) columns). Each column represents the proportion of IP-clusters or predictions containing the particular number of peak-groups. Total numbers of clusters or predictions are shown in parentheses in the legend.

FIG. 6 shows an illustration and analysis of the mass prediction for L-Methionine. (a) MetaboID output containing the m/z of peak-groups that make up the prediction, as well as their corresponding IP types. These m/z generate a mass prediction of 149.0508, which matches the database entry for L-Methionine (b). Listed in (c) are the m/z of peak-groups in the IP-cluster from which the prediction was derived. These are candidate IPs of L-Methionine as predicted by MetaboID. (d) 2D density maps showing all the candidate IPs being detected within a narrow RT range (1.4-1.6 min). (e) The extracted ion chromatograms for six of the most abundant candidate IPs. The m/z for each chromatogram is shown on top of each peak. All the peaks are well aligned and have very similar shapes, providing good evidence that they originate from the same metabolite. (f) The relative intensities across all the runs are plotted for four ions (m/z 133, 102, 104 and 727), along with the intensity ratios of three of them versus the most abundant ion (m/z 133). The ion at m/z 727 is not part of the IP-cluster, but has very similar RT, and is included to demonstrate how intensity ratios can be used to determine the correct IP candidates. (g) Molecular formulae of three candidate IPs are generated based on their m/z. The first ion is part of the original prediction, while the other two are not, as their IP types are not used in the present method. The molecular formulae help to explain how the ions form from the metabolite, and also serve to validate them as correctly predicted IPs of L-Methionine. (h) The predicted and detected isotopic patterns of the most abundant IP are compared to further confirm the molecular formula generated. The spectra show high degree of similarity in terms of m/z as well as intensity ratios of isotopic peaks.

FIG. 7 shows a visualization of LC-MS data. (a) Chromatogram of base (most intense) peaks (top panel) and spectrum at a single retention time (RT) point (bottom panel). The mass spectrometer scans the eluting analyte repeatedly to give a spectrum at different RT. (b) 2D density map of the entire run on the left, and on the right, a 3D plot (RT vs m/z vs intensity) of a selected map region. The lines on the density map represent peaks and the darker the line, the greater the intensity of the peak signal.

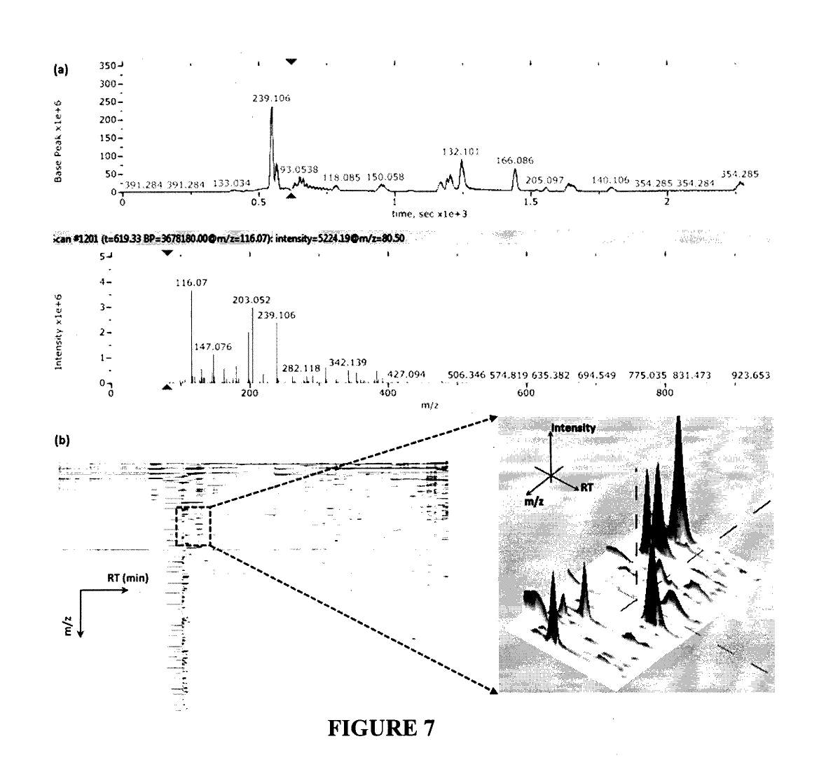

### DESCRIPTION

The following detailed description refers to the accompanying drawings that show, by way of illustration, specific details and embodiments in which the invention may be practiced. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

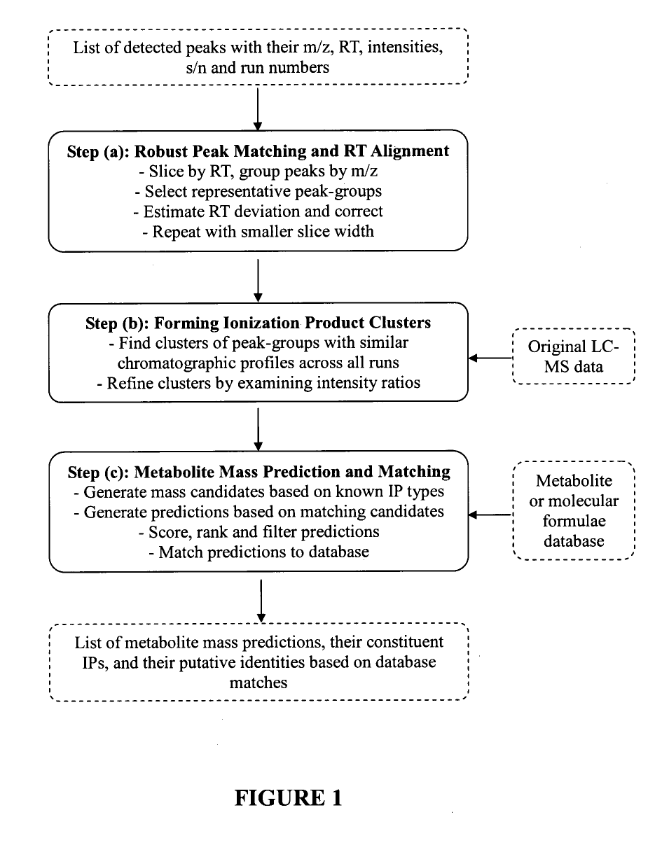

Various embodiments of the invention provide for a systematic and automated method for identifying metabolites with acceptable accuracy. As illustrated in FIG. 1, various embodiments of the present method for identifying metabolites present in a set of samples may include:

(a) forming a plurality of peak-groups, wherein each peak-group comprises mass peaks representative of a specific ion in each chromatographic run;

(b) forming a plurality of clusters, wherein each cluster comprises at least one peak-group of (a) each having similar chromatographic profiles; and

(c) generating a list of metabolite predictions, wherein each metabolite prediction is selected from the plurality of clusters of (b).

Prior to step (a) of forming a plurality of peak-groups, an input list of detected mass peaks, which can be generated by any peak detection (deconvolution) program available in pre-processing packages, is first obtained. For example, the XCMS package (Smith et al., Analytical Chem, 2006, 78, 779-787) may be used in the pre-processing. The table of peaks containing information on the mass-to-charge ratio (m/z), retention time (RT), integrated intensities (area under the peak), signal-to-noise ratio (s/n), and run number may then be exported, for example, as a tab-delimited text file as input for step (a).

In step (a), given the list of detected peaks, those peaks representing the same ion across each run are matched and grouped together to form features uniquely identifiable by their m/z and RT (hereinafter being referred to as peak-groups). Because the RTs of the peaks vary between runs, the RTs need to be aligned across all runs after the peak matching. By iterating through the process of peak matching and RT correction, alignment can be incrementally improved.

Due to the nature of the commonly used electrospray ionization (ESI) method, a single metabolite may be detected as several peaks. The pseudo-molecular ions [M+H]¹⁺ (where M represents the metabolite) and [M−H]¹⁻ are often assumed to be the most likely ions detected in the positive and negative ion modes, respectively. However, they may not necessarily be detected for all metabolites and many other ion types such as adducts, fragments, dimers, and multiple-charged species originating from the same metabolite may also be detected. Additionally, each ion is likely to produce isotopic peaks, especially when the monoisotopic signal is strong. These peaks that originate from the same metabolite are collectively hereinafter termed as ionization products (IPs). IPs complicate subsequent analysis as without careful examination of the data, it is difficult to determine which metabolite each IP is originated from. On the other hand, if the IPs of a particular metabolite are correctly grouped, they can provide additional evidence to support the putative identity of a metabolite.

Step (b) of the present method is directed to the forming of a plurality of clusters. Each IP-cluster, or simply termed as cluster, comprises at least one peak-group of step (a) each having similar chromatographic profiles. By analyzing the RT and intensities of mass peaks within the peak-groups, step (b) attempts to group the peak-groups into clusters of potential metabolite IPs. During this process, the original data may be loaded and examined in the mzXML format (Pedrioli et al., Nat. Biotechnol., 2004, 22(11), 1459-1966).

In step (c) of the present method, metabolite monoisotopic masses are predicted and scored based on the m/z relationships between peak-groups of the same cluster. These predictions are then searched against a user-defined metabolite or molecular formulae database to find matches within a specified mass tolerance. The final output from this step consists of a list of metabolite mass predictions, their constituent IPs, and their putative identities based on database matches.

Details for performing each of the step (a)-(c) will be discussed in the following paragraphs:

### Step (a): Forming a Plurality of Peak-Groups

Step (a) serves to provide robust peak matching and RT alignment across multiple chromatographic runs. This step involves matching peaks originating from the same ion across all individual LC-MS runs. A peak-group is formed by peaks representing the same ion detected in different runs. Measured RT may drift due to several factors such as changes in column performance during and between the analytical batches. Matching peaks into the correct peak-groups despite the variable RT is an important task because all subsequent steps make use of these features as the main representation of detected ions. Any errors will propagate and affect identification accuracy.

As discussed above, the method first requires a list of detected peaks as input. A preprocessing step is required to convert raw data from the mass detector into the input peak list. The open source XCMS software (see supra.) can be used to filter and detect peaks in the present implementation. The table of peaks containing peak information such as m/z, RT, intensities, signal-to-noise ratio (s/n), and run number is exported as a tab-delimited text file.

Unlike the peak matching algorithm in the popular XCMS package, which creates slices in the m/z dimension and then groups peaks with similar RT within each slice, the present method instead slices in the RT dimension first. Within each slice, the m/z of peaks are inspected to determine the appropriate peak-grouping. The high mass resolution that is commonly obtainable in current applications allows very robust peak-grouping even when RT deviates significantly across runs. This step allows a user to define a RT slice width, where this width is the assumed maximum deviation across the runs.

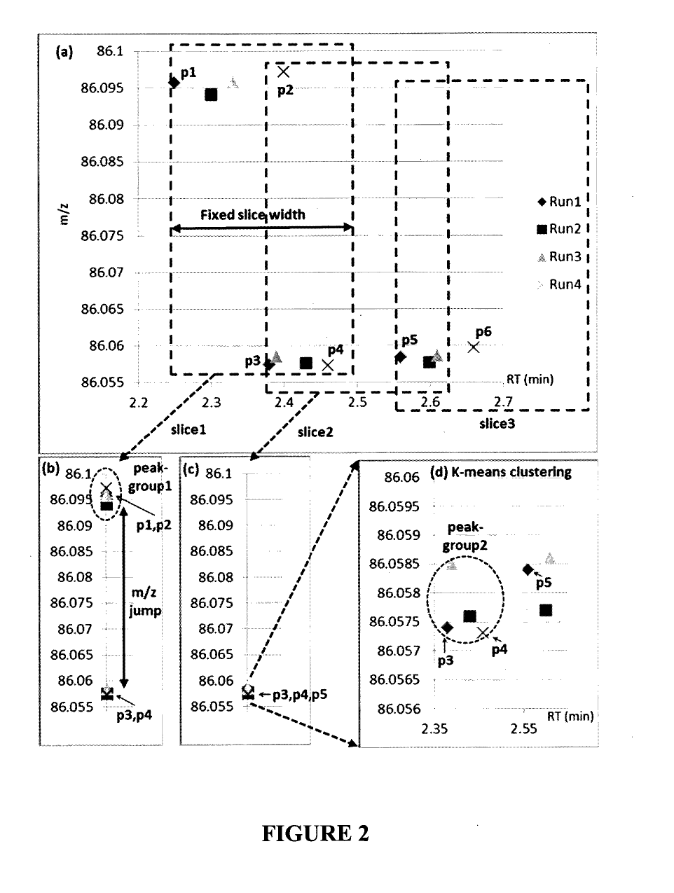

The peak matching step works by iterating the steps of isolating peaks within a RT range and then grouping them according to m/z. The list of detected peaks for the entire analytical batch is first sorted according to RT. Next, a sliding window, whose width is the user-specified slice width, is shifted across the RT domain and used to generate subsets of peaks whose RT falls within the window (FIG. 2(a)). Each time the slice shifts, it is moved such that the start of the slice is at the first ungrouped peak in the sorted list. This first ungrouped peak is designated to be the target peak to be matched with the appropriate peaks within the slice.

For each slice, the objective is to group the peaks closest to the target peak (i.e. the first peak with the lowest RT in the slice) in the m/z dimension. There are a few ways to carry out the grouping step. In one embodiment, a user-specified m/z range is used, such that peaks that are close to and within range of the target peak will be grouped together. The range can be specified either as absolute m/z value, or as parts-per-million (ppm), which is the ratio of the m/z difference (in this case, the range value) over the actual m/z value (in this case, the m/z of the target peak), multiplied by a million.

In an alternative embodiment, the Gaussian kernel density estimates of the range around the target peak's m/z value are calculated. The maximum value of the density estimate that is closest to the target peak is found and peaks near to this point are grouped together with the target.

In a further alternative embodiment, significant “jumps” in m/z values between adjacent peaks are determined. It is found that because of the high mass resolution, correctly matching peaks are almost always separated from other peaks by substantial gaps. The peaks are first sorted by their m/z. Next, starting from the target peak, the sorted list is scanned through to find instances where the m/z difference between adjacent peaks exceeds a user-specified threshold (FIG. 2(b)). Peaks before such “jumps” are grouped together with the target peak to form a peak-group.

Although the above “jump” method may be an effective way of correctly determining peak-groups, there can be instances where peak-groups contain more than one peak from the same run. This is usually the result of poor chromatographic separation of isomers or other ions that give very similar m/z, thus giving rise to peaks (from the same run) with very similar m/z and RT. In such cases, an additional step employing k-means clustering is performed to separate them (FIG. 2(c)). In this paragraph which briefly describes the k-means clustering methodology, it is to be understood that references to cluster (or clusters) are different from references to the IP-cluster (or simply cluster) mentioned elsewhere throughout the specification. Reference to cluster mentioned in this paragraph refers to cluster formed for the purposes of employing the k-means clustering methodology. Within the peak-group, the maximum number of peaks belonging to the same run is used as the value of k, which is the number of clusters to partition the peaks into. Clustering is performed in the two dimensions defined by RT and m/z. The first stage of cluster definition involves only runs with extra peaks. Clusters are iteratively refined until they do not change anymore. Subsequently the runs without extra peaks are included and their peaks are each associated to the nearest cluster. After clustering, the peak-group of the target peak will be defined by its cluster, while the rest of the peaks outside the cluster are left for subsequent RT slices.

After peak matching, runs are aligned in the chromatographic time domain by correcting their RT deviations. Representative peak-groups are first selected as anchors and used to estimate the RT deviation. These representatives are selected based on user-defined thresholds for the m/z range within each peak-group (i.e. the difference between the maximum and minimum m/z of peaks in the peak-group) and the number of peaks each group contains. RT deviation for the entire chromatogram is calculated from representative peak-groups by using locally weighted scatterplot smoothing (LOESS), the same technique employed by XCMS. For each run, the estimated deviations from a user-defined reference (usually the first run) are subtracted from the peaks to make the RT correction. Peak matching can then be repeated on the corrected results, with a smaller RT slice width. The process of matching and RT correction is usually iterated a few times to ensure good alignment of runs. The final set of peak-groups can additionally be filtered and checked using a number of criteria, such as average s/n, m/z range, and RT range within the peak-group.

Therefore, in various embodiments, forming a plurality of peak-groups may include:

(a) sorting the mass peaks in accordance with their respective retention times (RT);

(b) selecting a slice window having a slice width, wherein the slice width is selected to cover a range of RT;

(c) moving the slice window across the sorted mass peaks, wherein the start of the slice window is positioned at a first ungrouped mass peak within the slice window, wherein the first ungrouped mass peak is selected to be a target peak;

(d) sorting within the slice window the mass peaks in accordance with their respective mass-charge ratio (m/z); and

(e) grouping together mass peaks having m/z values close to that of the target peak.

In various embodiments, grouping together mass peaks having m/z values close to that of the target peak may include:

(a) obtaining the difference in m/z values between adjacent mass peaks;

(b) comparing the difference with a predetermined threshold for the difference in m/z values; and

(c) grouping together the mass peaks whose difference in m/z values is below the predetermined threshold for difference in m/z values.

In various embodiments, forming a plurality of peak-groups may be corrected and repeated prior to forming a plurality of clusters. In one embodiment, forming a plurality of peak-groups may be corrected and repeated several times with decreasing slice widths for the slice window. This may be done, for example as described above, by first correcting the RT of peaks, followed by repeating the peak matching with a smaller slice width based on the corrected results.

### Step (b): Forming a Plurality of Clusters

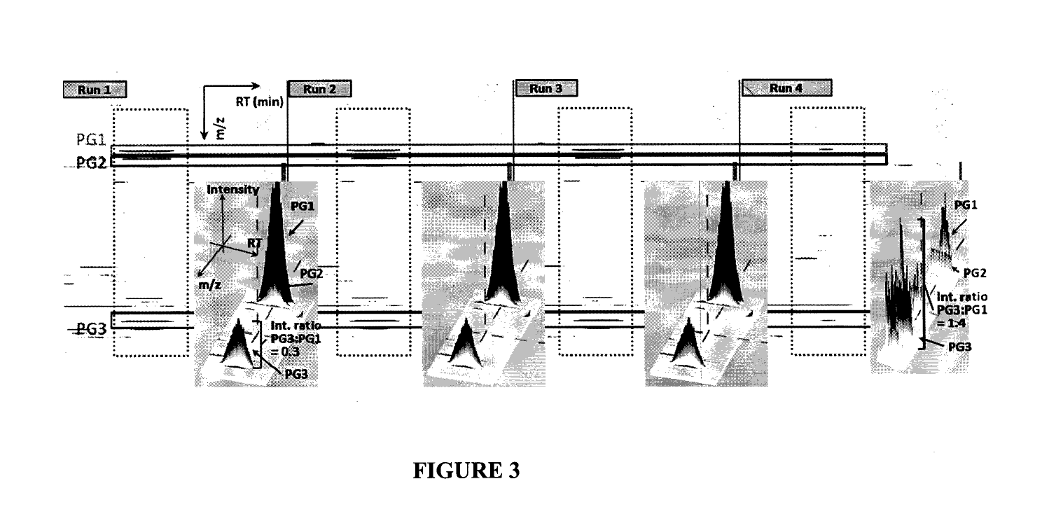

Step (b) serves to generate and determine ionization product clusters. This step aims to accurately cluster a metabolite's ionization products (IPs) together, such that further analysis can be more easily performed on the smaller sets of features. The step makes use of two key observations: (1) IPs are formed after chromatographic elution of the metabolite, thus their peaks should have the same shapes and locations along the RT axis; (2) IPs of the same metabolite should have covariant intensities across measurement runs if the ionization and detection conditions are unchanged. Exploiting these observations, peak-groups are first clustered based on their chromatographic shapes and further refined by examining their intensities. This is outlined by the example in FIG. 3.

Based on the first observation, the step first needs to find clusters of peak-groups with similar chromatographic peak shapes and locations (hereinafter termed IP-clusters). A similarity measure is used to quantify the degree of similarity between two peaks. In the present implementation, this measure is the Pearson's correlation coefficient, which gives an indication of how linearly related the points representing the two peaks are. For each run, the original LC-MS data is accessed to compare each peak with every other peak that is nearby in the chromatographic time domain. The correlation coefficients are then averaged across all runs in order to calculate the similarities between peak-groups of the entire batch.

Given the matrix of similarity scores between peak-groups, the next step is to find clusters whose elements are all similar to each other. This step adopts a variation of Quality Threshold (QT) clustering (Heyer et al., Genome Research, 1999, 9, 1106-1115), which generates clusters with similarity scores above a user-defined threshold. The QT method is adapted to produce overlapping clusters instead of disjoint ones so as to model the uncertainty of whether a peak-group belongs to one cluster or another with very similar RT. As the clusters will be refined and processed in subsequent steps, it is more conservative to allow peak-groups to belong to multiple clusters at this stage.

The QT method generates candidate clusters for every peak-group before filtering and merging them to form the final set of IP-clusters. A peak-group is first added to its own candidate cluster. The next most similar peak-group is then added to the cluster provided that its similarity score is still above the threshold. This similarity score is defined as the minimum of the correlation coefficients between the cluster elements. Peak-groups are added to the cluster until the threshold is crossed. This candidate cluster generation is repeated for all peak-groups. Next, the clusters are filtered and merged. Those that are subsets of another cluster are removed. Clusters that overlap by more than a user-specified proportion are merged to form larger clusters. The resulting set of IP-clusters will still have overlaps with each other.

After finding IP-clusters based on RT, the next task is to refine the results based on the relationship of peak intensities across the runs. It is now easier to inspect the peak-groups as they are organized into smaller IP-clusters. The intensity ratio between two IPs of the same metabolite should theoretically remain constant across all runs even as metabolite concentration varies across samples. As such, the coefficient of variation (CV) of intensity ratio is used to split the IP-clusters, where CV is the standard deviation divided by the mean and gives the normalized spread of intensity ratios across all runs. Peak-groups with high CV when paired with other constituents of a cluster indicate highly fluctuating intensity ratios and are separated to form another cluster. CV is the chosen measure over Pearson's correlation coefficient as the latter gives spurious values when peak intensities have small variations across runs. For each IP-cluster, the step proceeds by first sorting the elements according to decreasing maximum s/n. It then inserts the first peak-group into a new IP-cluster. Going down the sorted list, every peak-group with CV below a pre-defined threshold when paired with the first element is also inserted into the new IP-cluster. Once the sorted list is gone through, the process is repeated to generate other new IP-clusters from the remaining elements. This essentially splits the original IP-cluster into new refined clusters whose elements have relatively constant intensity ratios across runs.

Therefore, in various embodiments, forming a plurality of clusters may include grouping together peak-groups each having similar chromatographic peak shapes and locations corresponding to one another. In various embodiments, grouping together of peak-groups may include:

(a) quantifying the degree of similarity between two mass peaks for each chromatographic run;

(b) quantifying the degree of similarity between two peak-groups based on the degree of similarity between two mass peaks;

(c) comparing the degree of similarity between two peak-groups with a predetermined threshold for the degree of similarity; and

(d) grouping together peak-groups whose degree of similarity is above the predetermined threshold for the degree of similarity.

In various embodiments, forming a plurality of clusters may further include refining the grouping together peak-groups whose degree of similarity is above the predetermined threshold for the degree of similarity. In one embodiment, refining may include:

(a) obtaining a first intensity ratio of two corresponding mass peaks of a first chromatographic run in each peak-group;

(b) repeating the step of (a) to obtain a subsequent intensity ratio of a subsequent chromatographic run;

(c) quantifying the coefficient of variation of intensity ratios;

(d) comparing the coefficient of variation with a predetermined threshold for the coefficient of variation; and

(e) grouping together peak-groups whose coefficient of variation of intensity ratios is below the predetermined threshold for the coefficient of variation of intensity ratios.

The coefficient of variation provides an indication of the amount of fluctuation of intensity ratios across all the chromatographic runs. A low coefficient of variation of intensity ratios would indicate that the mass peaks of the first chromatographic run and of the subsequent chromatographic runs are likely to originate from the same metabolite.

### Step (c): Generating a List of Metabolite Predictions

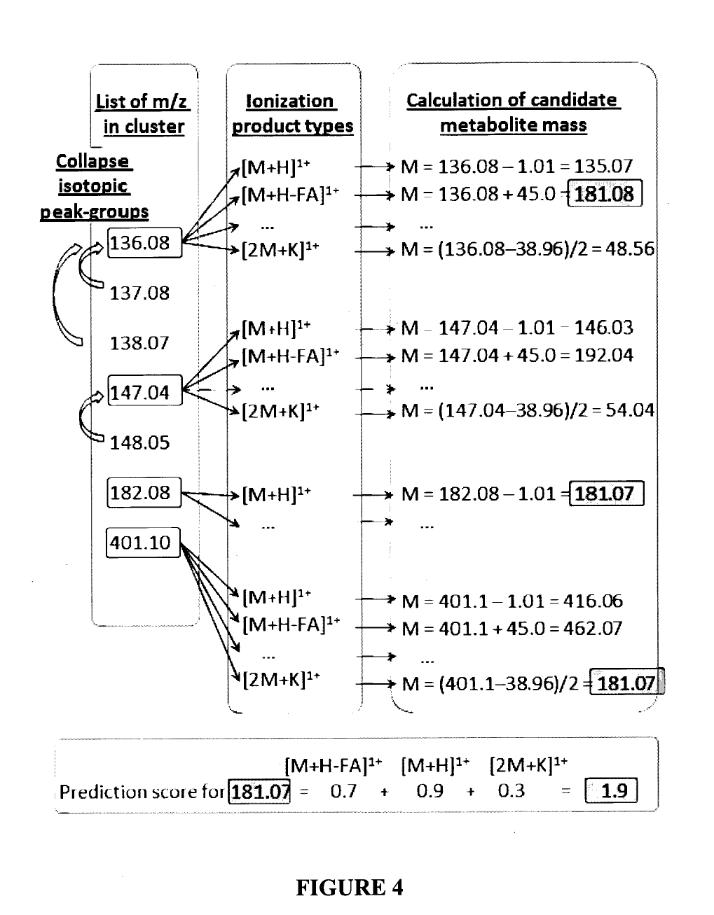

Step (c) serves to provide metabolite mass prediction and database matching. In this step, metabolite accurate masses are predicted by inspecting the m/z of peak-groups in the refined IP-clusters. The number of peak-groups in each IP-cluster is much smaller relative to the entire feature set, thus allowing for easier and more accurate metabolite mass prediction. This works by generating a list of all possible metabolite mass candidates based on a set of IP types known to form, and then finding candidates that match. FIG. 4 gives a simplified example.

Within each cluster, isotopic peak-groups are first linked to their corresponding monoisotopic peak-group and removed from the cluster. This is done by searching for m/z differences that are near to 1 (for singly-charged ions) and 0.5 (for doubly-charged ions). The predicted charge is also stored and used as a filter during mass candidate generation.

Next, metabolite mass candidates are generated for each of the monoisotopic peak-groups, using a list of possible IP types. A candidate metabolite mass is reversely calculated from the m/z of a peak-group, using the formula of an IP type. Given the peak-group m/z (P), the adduct mass (A), the charge (C), and the number of metabolite molecules in the IP type (N), the metabolite mass is given by M=((C×P)−A)÷N. The values for A, C and N are known based on the IP formula. For example, given the IP formula [2M+H]¹⁺, the mass of the adduct is that of a proton (A=1.007), the charge C is 1, and N is 2. If a peak-group has an m/z of P=883.287, then the candidate mass will be M=((1×883.287)−1.007)÷2=441.14.

Lastly, the full list of candidate masses is searched for values that are highly similar within an error threshold. Valid mass predictions are formed by two or more matching candidates, while the rest of the candidates are removed from consideration. Matching candidates correspond to peak-groups that comply with the predicted combination of IP types. For those peak-groups that are not associated with any valid prediction, the default IP type ([M+H]¹⁺ or [M−H]¹⁻) is used to derive the corresponding metabolite mass.

All predictions are scored so that they can be ranked according to confidence. Each IP type is associated with a score that is proportional to the probability of such ions occurring, whereby the scores are user-defined and can be adjusted and optimized depending on the analytical conditions. The total score of a prediction is calculated by summing the scores of the corresponding IP types used to generate the prediction. A high prediction score would mean that the prediction is generated from a number of high-probability IP types, thus indicating that such a combination is well supported by evidence from different detected ions. The ranked predictions can be additionally filtered for only the top-scoring ones, such that each peak-group is associated to only one prediction. To generate putative identities, the mass predictions are matched within a specified error tolerance to the exact masses of known metabolites in a database.

Therefore, in various embodiments, generating a list of metabolite predictions may include:

(a) identifying monoisotopic peak-groups in each cluster;

(b) computing for each monoisotopic peak-group the respective candidate metabolite masses based on a list of possible adducts, fragments and complexes formulae for the metabolite;

(c) grouping together candidate masses that are highly similar to form metabolite mass predictions; and

(d) matching the metabolite mass predictions with a database of known metabolites to identify the metabolites present in the set of samples.

In various embodiments, identifying monoisotopic peak-groups in each cluster may include determining isotopes and charges based on the differences in m/z values. Monoisotopic peak-groups refer specifically to isotopic peak-groups representing ions that are made up of the most abundant isotope for each element. Isotopic peak-groups that do not represent ions that are made up of the most abundant isotope for each element are link to or collapsed into their respective monoisotopic peak-groups. In various embodiments, the monoisotopic peak-groups may be identified by searching for m/z differences that are near to 1 (for singly-charged ions) and 0.5 (for doubly-charged ions).

In various embodiments, computing the respective candidate metabolite masses may include calculating the candidate metabolite mass from the m/z of a peak-group based on the formula of an IP type. A list of candidate metabolite masses may be generated.

In various embodiments, grouping together candidate masses that are highly similar to form metabolite mass predictions may include searching for candidate masses that fall within an error threshold set by a user. Candidates having matching masses are grouped together to form a metabolite mass prediction. Each of the metabolite mass predictions may then be given a score and may be ranked in accordance with its respective score. The ranked predictions may then be filtered by retaining only the top-scoring prediction for each peak-group.

In order that the invention may be readily understood and put into practical effect, particular embodiments will now be described by way of the following non-limiting examples.

### EXAMPLES

### Sample Preparation, Analytical Method and Data Preprocessing

For the generation of experimental data used to validate the present method, culture supernatant was obtained daily from duplicate fed-batch cultures of a Chinese Hamster Ovary (CHO) cell line producing a recombinant antibody against the Rhesus D antigen (Chusainow et al., Biotechnol. Bioeng., 2009, 102, 1182-1196). The cultures were grown in an in-house proprietary protein-free, chemically defined (PFCD) media and online sampling of glutamine/glutamate level was conducted every 1.5 hours to determine the amount of protein-free feed, formulated based on a fortified 10×DMEM/F12 (Hyclone, USA), required to maintain cultures at a pre-set glutamine level of 0.6 mM. The supernatant samples were filtered through a 10 kDa molecular weight cut-off device (Vivaspin 500 PES membrane, Sartorius AG, Germany) by centrifugation at 4° C. for 30 min. The filtered samples were diluted 1:1 with sample buffer comprising of 20% (v/v) methanol (Optima grade, Fisher Scientific, USA) in water prior to analysis.

Each sample was analyzed in replicate using an ultra-performance liquid chromatography (UPLC) system (Acquity, Waters Corp., USA) coupled to a mass spectrometer (LTQ-Orbitrap, Thermo Scientific, USA). A reversed phase (C18) UPLC column with polar end-capping (Acquity UPLC HSS T3 column, 2.1×100 mm, 1.7 μm, Waters Corp.) was used with two solvents: ‘A’ being water with 0.1% formic acid (Merck, USA), and ‘B’ being methanol (Optima grade, Fisher Scientific) with 0.1% formic acid. The UPLC program was as follows: the column was first equilibrated for 0.5 min at 0.1% B. The gradient was then increased from 0.1% B to 50% B over 8 min before being held at 98% B for 3 min. The column was washed for a further 3 min with 98% acetonitrile (Optima grade, Fisher Scientific) with 0.1% formic acid and finally equilibrated with 0.1% B for 1.5 min. The solvent flow rate was set at 400 μlmin⁻¹; a column temperature of 30° C. was used. The eluent from the UPLC system was directed into the mass spectrometer (MS). Electrospray ionization (ESI) was conducted in both positive and negative modes in full scan with a mass range of 80 to 1000 m/z at a resolution of 15000. Sheath and auxiliary gas flow was set at 40.0 and 15.0 (arbitrary units) respectively, with a capillary temperature of 400° C. The ESI source and capillary voltages were 4.5 kV and 40 V respectively, for positive mode ionization, and 3.2 kV and −15 V, respectively, for negative mode ionization. Mass calibration was performed using standard LTQ-Orbitrap calibration solution (Thermo Scientific) prior to injection of the samples.

The raw LC-MS data obtained was then converted to the generic mzXML format. Peak detection was then performed using the preprocessing software XCMS, where the “matchedFilter” algorithm was used with parameters: snthresh=2, step=0.05, mzdiff=0.1, and fwhm=3. Lastly, the entire list of detected peaks was saved as a tab-delimited text file for input.

### Results and Discussion

The performance of present method was evaluated on a dataset generated from Chinese Hamster Ovary (CHO) cell culture supernatant samples. These were analyzed using an ultra-performance liquid chromatography (UPLC) system coupled to an LTQ-Orbitrap MS, in both positive and negative ion modes. For each mode, a total of 119 chromatographic runs from the same analytical batch were included for analysis. Four replicate runs were produced for each culture sample, along with eighteen replicate runs for a chemically defined media which were distributed throughout the analytical batch. For quality control, eighteen runs from a pooled sample, similarly distributed throughout the batch, as well as one blank run (pure water) were also included.

### Peak Matching Comparison

The present peak matching step (a) was evaluated by comparing with XCMS's method. This was done in the positive mode dataset. A common set of 574816 peaks (4830 peaks per run on average) was generated using XCMS's peak detection and used for the comparison. The peak list was exported and input for peak matching. After one round of RT alignment as well as an inbuilt peak-group filter, a total of 5895 peak-groups was produced. The inbuilt filter requires peak-groups to have: (1) peaks present in all replicates of at least one sample, and (2) mean signal-to-noise ratio (s/n) of replicate peaks to be >3 for at least one sample. For XCMS, one round of RT alignment was similarly executed using the following peak matching settings: “mzwid” at 0.05 and “bw” at 4. The peak-groups were subjected to the same filter as above, resulting in a total of 5195 peak-groups remaining. These peak-groups were then matched to those of the present method at an m/z tolerance of ±10 parts-per-million (ppm) and RT tolerance of ±5 seconds (s). 91% (4745) of the XCMS peak-groups matched, indicating that both methods gave very similar peak matching results. Most of those XCMS peak-groups that did not match had weak constituent peak signals, with only 37% of peaks present on average and with mean s/n of 5, compared to the overall figures of 73% and 8 respectively.

Many of the XCMS peak-groups consisted of more peaks (86 peaks present on average in XCMS versus 76 in the present method). This is likely due to the present method's ability to partition peaks with very similar m/z and RT, using the clustering step adopted to separate peaks from the same run. It is observed that many XCMS peak-groups contained extra peaks from the same run, while these were accurately separated in the present method's case. For instance, there were 8 XCMS peak-groups that each contained 236 peaks, whereas with the present method, these were evenly split into peak-groups containing 118 peaks, each forming tight clusters in the m/z and RT dimensions. The presence of extra peaks appears to skew the m/z of the XCMS peak-groups, thus contributing to some of the mismatches with the present method.

### Identification of Media Metabolites

In an attempt to validate the present identification method, the ability of the present method to predict the masses of metabolites found in the culture media was assessed. A total of 33 known components of the media were included in the analysis, where these metabolites had been previously investigated in-house and determined to be detectable by the present inventors' instruments.

After peak matching, three additional filtering steps were incorporated to remove noise and instrument artifacts. First, peak-groups were removed if they did not contain any peak with s/n that was more than 1.5 times that of peaks from the pure water runs. Second, by analyzing replicate runs of the pooled sample, peak-groups that did not have consistently reproducible intensities were removed. A 15% cutoff on the CV of intensities across these replicate runs was used as the filter. Third, all peak-groups with RT>9 min were removed. These steps significantly reduced the number of features for identification, with the number of peak-groups decreasing by 70% (5895 to 1748) in the positive ion mode and 53% (2752 to 1291) in the negative mode.

The remaining peak-groups were then processed by the present method's IP clustering and metabolite mass prediction steps. Only the top-scoring predictions, obtained after filtering based on prediction score, were considered. These were then assigned putative metabolite identities by matching their predicted masses (within a mass tolerance of ±10 ppm) to a combined database of KEGG and HMDB entries. The mass predictions were also similarly matched against the masses of the 33 media metabolites to determine how many of those could be correctly identified.

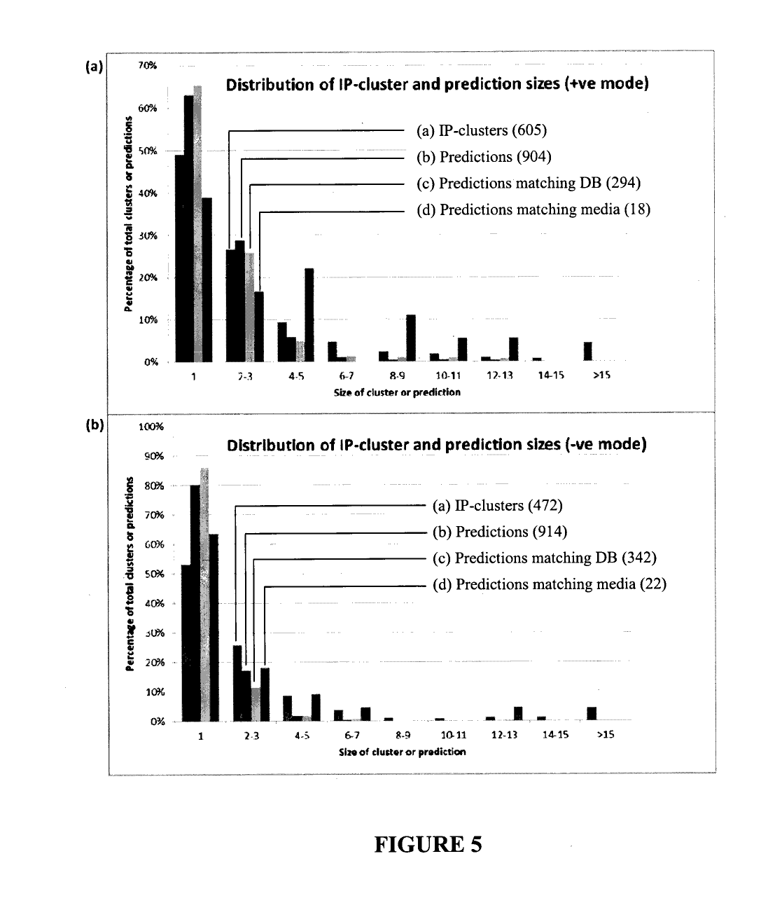

The distributions of cluster and prediction sizes are plotted in FIG. 5. In each mode, the size distributions remain largely similar, although there are generally higher proportions of IP-clusters with sizes greater than one, when compared to predictions. It can be seen that most of the IP-clusters in both modes have relatively small sizes, suggesting that the present method was able to partition the features into clusters of manageable sizes. Since each cluster can be analyzed independently, the small cluster sizes facilitate improved metabolite identification. In the positive mode, the average sizes of IP-clusters and total predictions are 3.8 and 1.7 respectively, while these are 2.4 and 1.3 respectively in the negative mode. Comparing both modes, the higher average sizes in the positive mode agrees with previous observations that more IPs tend to form in this mode.

Out of the 33 media metabolites studied, 28 (85%) were correctly identified by predictions made using the present method (Table 1).

TABLE 1
List of 33 media metabolites studied.

| | Identified in | | | |
|---|---|---|---|---|
| | Positive | Identified in | Identified | Identified |
| Media Metabolite | Mode | Negative Mode | in either | in both |
| L-Alanine | Yes | No | Yes | No |
| L-Arginine | Yes | Yes | Yes | Yes |
| L-Asparagine | Yes | No | Yes | No |
| L-Aspartic Acid | No | Yes | Yes | No |
| L-Cysteine | No | Yes | Yes | No |
| L-Cystine | Yes | No | Yes | No |
| L-Glutamic Acid | No | Yes | Yes | No |
| L-Glutamine | Yes | Yes | Yes | Yes |
| L-Histidine | No | Yes | Yes | No |
| L-Isoleucine | Yes | Yes | Yes | Yes |
| L-Leucine | No | Yes | Yes | No |
| L-Lysine | No | Yes | Yes | No |
| L-Methionine | Yes | Yes | Yes | Yes |
| L-Phenylalanine | Yes | Yes | Yes | Yes |
| L-Proline | Yes | Yes | Yes | Yes |
| L-Serine | No | Yes | Yes | No |
| L-Threonine | No | Yes | Yes | No |
| L-Tryptophan | Yes | Yes | Yes | Yes |
| L-Tyrosine | Yes | Yes | Yes | Yes |
| L-Valine | Yes | No | Yes | No |
| Pantothenate | Yes | Yes | Yes | Yes |
| Choline | No | No | No | No |
| Folic Acid | Yes | Yes | Yes | Yes |
| Myo-Inositol | No | Yes | Yes | No |
| Niacinamide | Yes | No | Yes | No |
| Riboflavin | Yes | Yes | Yes | Yes |
| Thiamine | No | No | No | No |
| Vitamin B12 | Yes | No | Yes | No |
| D-Glucose | No | No | No | No |
| Hypoxanthine | Yes | Yes | Yes | Yes |
| Pyruvate | No | No | No | No |
| Thymidine | No | No | No | No |
| Ferric Citrate | No | Yes | Yes | No |
| Total | 18 | 22 | 28 | 12 |

In the positive mode, 18 media metabolites were identified while in the negative mode, this was 22 (there were 12 identified in both modes). It could not be identified any additional metabolites when all peak-groups were used to directly search for media metabolites based on the pseudo-molecular ions ([M+H]¹⁺ and [M−H]¹⁻). This indicates that the present predictions did not leave out metabolites that could be identified by traditional means. By manually searching the filtered list of peak-groups for ions of the five metabolites that were not identified, it was only able to find the ions for two of them. One of them is glucose, which forms only the sodium adduct ([M+Na]¹⁺) in the positive mode. The other metabolite, choline, is a positively charged ion ([M]¹⁺). For glucose, the present method was not able to generate a matching mass prediction because no other known type of IP was formed. As such, the mass prediction step could not pair the mass candidate of the sodium adduct with any other candidate, hence the prediction defaulted to the mass calculated based on the [M+H]¹⁺ ion. Similarly for choline, no other known IP was detected so the prediction used the default [M+H]¹⁺ ion. Examining the IP-clusters for these two metabolites, it was found that choline only had two peak-groups in its cluster and these were isotopic peaks. The IP-cluster for glucose had three peak-groups, two of them were the sodium adduct and its isotopic peak, while the third ion could not be identified. Next, the raw MS data for the ions of the remaining three unidentified metabolites was searched and only the sodium adduct signal for one of them could be found. This signal was very weak and thus was filtered from the peak-group list used for identification.

In the positive mode, the average size of correct media metabolite predictions was 4.1, with the size distribution skewed towards higher numbers compared to IP-clusters and all predictions (FIG. 5). This could possibly be due to more IPs detectable as a result of higher concentrations of media metabolites as compared to other metabolites from the culture. The average size of media metabolite predictions in the negative mode is smaller at 2.5.

Because the present predictions are generated from a combination of IPs instead of simply relying on the pseudo-molecular ions, it was able to identify metabolites even when these ions are in low abundance. In the positive mode, the present method correctly identified two additional metabolites whose [M+H]¹⁺ ion was not detected. Additionally, there were several cases where the [M+H]¹⁺ was not the strongest signal produced by the metabolite, with another IP having much higher abundance. This is important because the more abundant ion would be more informative as the representative feature for the metabolite in global metabolic profile analyses.

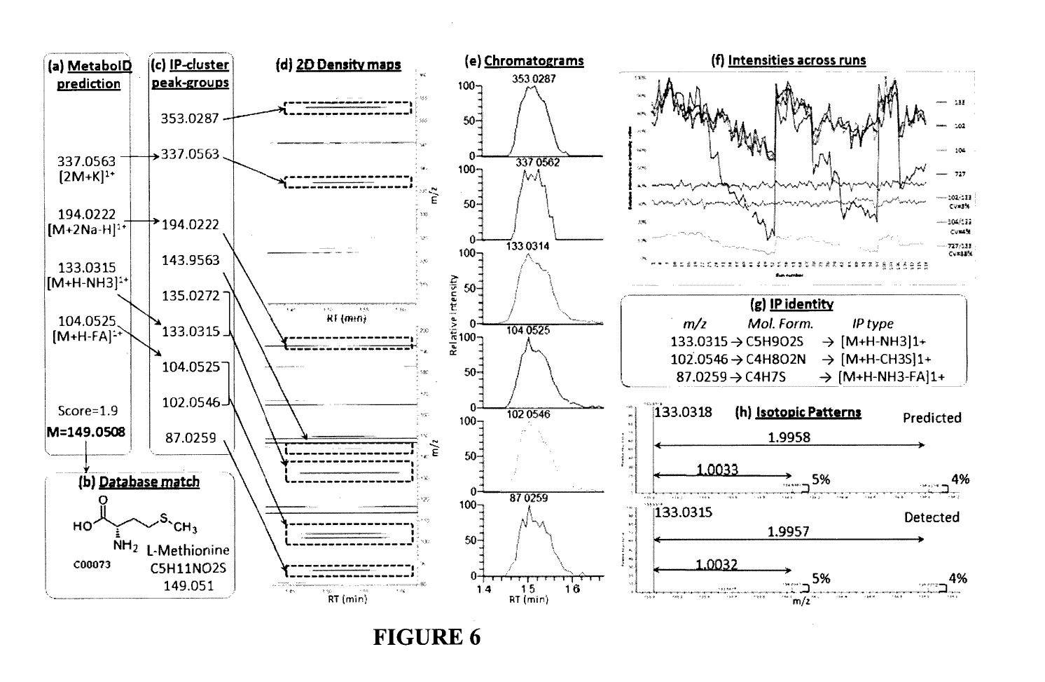

FIG. 6 illustrates an example of a correctly identified media metabolite whose [M+H]¹⁺ ion was not detected, yet the present method was able to predict its metabolite mass from other IPs. Four peak-groups were found to conform to a particular combination of IPs, generating a mass prediction that matched to L-Methionine. When the IP-cluster was inspected from which this prediction was generated, it was found that all nine ions had very similar chromatographic profiles (FIG. 6(e)). This suggests that the method is effective at generating accurate clusters. By examining the intensity profiles of these ions across all the runs, it was found that all of those belonging to the same IP-cluster had approximately constant intensity ratios (FIG. 6(f)). The intensity profiles were compared to another ion (m/z 727) whose chromatographic profile was very similar to the rest of the IPs. It was found that the intensity ratio of this ion fluctuated significantly with a CV of 38%, which was significantly higher than that of the other ions (CV<5%). This provided strong evidence for its exclusion from the IP-cluster, which the step correctly performed. Note that when the Pearson's correlation coefficient was used to compare intensity profiles, the ion at m/z 727 had a similar value as the other ions (>0.8). Thus in this instance, CV of intensity ratio was a more sensitive measure for determining candidates for an IP-cluster. By generating molecular formulae based on m/z, the identity of ions in the IP-cluster that had not been part of the prediction (FIG. 6(g)) was further determined. These were found to be neutral losses that were not listed as known IP types used for prediction. This analysis validates the present method's ability to effectively cluster IPs and make accurate mass predictions. The generation of predictions from multiple ions contributes to the confidence of putative identification, since it is unlikely for multiple m/z signals to by chance occur in the same cluster and also conform to a specific IP combination. The analysis also demonstrates the utility of IP-clusters in aiding the identification of other IPs that have not been accounted for by the prediction. This concurrently provides further confirmation for the metabolite identity.

By generating mass predictions, the present method significantly reduced the number of features to be identified (by 48% and 29% in the positive and negative modes respectively). In turn, this would likely lead to fewer false-positive database matches when compared to the direct method of matching masses calculated from the pseudo-molecular ions. Although it is not able to assess this reduction directly—due to the fact that it is not known the identity of all metabolites in the samples—it was able to estimate this figure based on the media metabolite predictions. For the predictions in the positive mode, ˜10% of the IPs that were not predicted to be [M+H]¹⁺ ions by the present method had database matches when matched directly. These were very likely to be false-positives since they were already associated to correctly identified metabolites. Since only 25% of the entire peak-group list had database matches, if this 10% figure was extrapolated to the entire list, it may be the case that up to 40% of database matches in the entire list may be false-positives that can be prevented by the present method. Hence it can be seen that the method is able to reduce erroneous leads and instead, generate more confident identity predictions.

### CONCLUSIONS

The present inventors have provided a method for simplifying complex LC-MS data and generating predictions for putative metabolite identification. The method intelligently integrates multiple sources of information to generate more confident leads that can be used as starting points for resource intensive definitive identification.

The method first aligns chromatographic runs using a novel peak matching algorithm that is catered for high mass resolution data and is robust to large RT deviations. Next, by inspecting RT and peak intensity relationships, a sophisticated algorithm groups features into clusters of ions that potentially originate from the same metabolite. From these clusters, the method intelligently generates metabolite mass predictions by exhaustively searching for m/z relationships between features of the same cluster. These predictions can then be used to search for matching records in a database, giving putative identities.

The present method has been validated by applying it to experimental metabolic profiles of cell culture supernatant analyzed using UPLC coupled to an Orbitrap MS. It has been demonstrated that the present method is able to correctly predict the masses of most of the known media components in the samples. Compared to traditional methods, the present method generates significantly fewer metabolite predictions without missing out valid ones, thus reducing data complexity and false-positive database matches. Because each prediction consists of multiple features that are in agreement with a specific combination of ions known to form, improved confidence of identification is achieved. By carefully clustering features that are potentially derived from the same metabolite, the method greatly simplifies the data for the user in situations when the features need to be manually investigated. In summary, the present method improves the accuracy, confidence and efficiency of the putative identification process, thus providing crucial savings on time, resources and manual work.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numberical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. A method for identifying metabolites present in a set of samples, the method comprising:
(a) forming a plurality of peak-groups, wherein each peak-group comprises mass peaks representative of a specific ion in each chromatographic run;
(b) forming a plurality of clusters, wherein each cluster comprises at least one peak-group of (a) each having similar chromatographic profiles; and
(c) generating a list of metabolite predictions, wherein each metabolite prediction is selected from the plurality of clusters of (b),
wherein forming the plurality of peak-groups comprises:
(i) sorting the mass peaks in accordance with their respective RT;
(ii) selecting a slice window having a slice width, wherein the slice width is selected to cover a range of RT;
(iii) moving the slice window across the sorted mass peaks, wherein the start of the slice window is positioned at a first ungrouped mass peak within the slice window, wherein the first ungrouped mass peak is selected to be a target peak;
(iv) sorting within the slice window the mass peaks in accordance with their respective mass-charge ratio (m/z); and
(v) grouping together mass peaks having m/z values close to that of the target peak.

2. The method of claim 1, further comprising generating a list of mass peaks prior to forming the plurality of peak-groups of (a).

3. The method of claim 2, wherein the list of mass peaks comprises data selected from the group consisting of mass-to-charge ratio (m/z), retention time (RT), integrated intensities, signal-to-noise ratio (s/n), run number, and combination thereof.

4. (canceled)

5. The method of claim 1, wherein sorting the mass peaks comprises sorting the mass peaks in an increasing order of the RT.

6. The method of claim 1, wherein moving the slice window comprises moving the slice window across the sorted mass peaks in a direction of increasing RT.

7. The method of claim 1, wherein sorting within the slice window the mass peaks comprises sorting within the slice window the mass peaks in an increasing order of m/z.

8. The method of claim 1, wherein grouping together mass peaks comprises grouping together mass peaks having m/z values falling within a predetermined m/z range from the target peak.

9. The method of claim 1, wherein grouping together mass peaks comprises:
(a) calculating Gaussian kernel density estimate of each mass peak;
(b) obtaining the difference in Gaussian kernel density estimate between each mass peak and the target peak;
(c) comparing the difference with a predetermined threshold for the difference in Gaussian kernel density estimate; and
(d) grouping together the mass peaks whose difference in Gaussian kernel density estimate is below the predetermined threshold for the difference in Gaussian kernel density estimate.

10. The method of claim 1, wherein grouping together mass peaks having m/z values close to that of the target peak comprises:
(a) obtaining the difference in m/z values between adjacent mass peaks;
(b) comparing the difference with a predetermined threshold for the difference in m/z values; and
(c) grouping together the mass peaks whose difference in m/z values is below the predetermined threshold for the difference in m/z values.

11. The method of claim 8, further comprising performing a k-means clustering analysis in the RT and m/z dimensions after grouping together the mass peaks.

12. The method of claim 1, comprising repeating the operation of forming the plurality of peak-groups by re-selecting the slice width of the slice window.

13. The method of claim 12, wherein prior to re-selecting the slice width of the slice window, the RT of peaks are corrected and the forming of the plurality of peak-groups is performed based on the corrected RT.

14. The method of claim 1, wherein forming the plurality of clusters comprises grouping together peak groups each having similar chromatographic peak shapes and locations corresponding to one another.

15. The method of claim 14, wherein grouping together of peak-groups comprises:
(a) quantifying the degree of similarity between two mass peaks for each chromatographic run;
(b) quantifying the degree of similarity between two peak-groups based on the degree of similarity between two mass peaks;
(c) comparing the degree of similarity between two peak-groups with a predetermined threshold for the degree of similarity; and
(d) grouping together peak-groups whose degree of similarity is above the predetermined threshold for the degree of similarity.

16. The method of claim 15, wherein peak-groups whose degree of similarity is above the predetermined threshold for the degree of similarity are grouped together by using a modified Quality Threshold (QT) clustering technique.

17. The method of claim 16, wherein the modified QT clustering technique comprises generating a list of candidate IP-clusters by:
(i) forming a first candidate IP-cluster containing a first peak-group and adding subsequent peak-groups having degrees of similarity above a predetermined threshold; and
(ii) repeating the operation of (i) to form subsequent IP-clusters for remaining peak-groups.

18. The method of claim 15, further comprising refining grouping together peak-groups whose degree of similarity is above the predetermined threshold for the degree of similarity.

19. The method of claim 18, wherein refining comprises:
(a) obtaining a first intensity ratio of two corresponding mass peaks of a first chromatographic run in each peak-group;
(b) repeating the operation of (a) to obtain a subsequent intensity ratio of a subsequent chromatographic run;
(c) quantifying the coefficient of variation of intensity ratios;
(d) comparing the coefficient of variation with a predetermined threshold for the coefficient of variation; and
(e) grouping together peak-groups whose coefficient of variation of intensity ratios is below the predetermined threshold for the coefficient of variation of intensity ratios.

20. The method of claim 1, wherein generating the list of metabolite predictions comprises:
(a) identifying monoisotopic peak-groups in each cluster;
(b) computing for each monoisotopic peak-group the respective candidate metabolite masses based on a list of possible adducts, fragments and complexes formulae for the metabolite;
(c) grouping together candidate masses that are highly similar to form metabolite mass predictions; and
(d) matching the metabolite mass predictions with a database of known metabolites to identify the metabolites present in the set of samples.

21. The method of claim 20, wherein identifying monoisotopic peak-peak-groups in each cluster comprises determining isotopes and charges based on the differences in m/z values.

22. The method of claim 21, monoisotopic peak-groups are identified by searching for m/z differences that are about 1 for singly-charged ions or 0.5 for doubly-charged ions.

23. The method of claim 22, wherein computing for each monoisotopic peak-group the respective candidate metabolite masses comprises calculating the candidate metabolite mass from the m/z of a peak-group based on the chemical formula of an ionization product.

24. The method of claim 23, wherein grouping together candidate masses to form metabolite mass predictions comprises:
(i) searching for candidate masses falling within a predetermined error threshold;
(ii) grouping together candidates having masses falling within the predetermined error threshold to form a respective metabolite mass prediction;
(iii) allocating a score to each metabolite prediction;
(iv) ranking the metabolite predictions based on their scores; and
(v) retaining highly-ranked metabolite predictions.

25. (canceled)

26. (canceled)
